(19) United States
(12) Patent Application Publication
(10) Pub. No.: US 2025/0265082 A1
(43) Pub. Date: Aug. 21, 2025

(54) COMPUTATION ENGINE WITH SPARSE MATRIX INSTRUCTION

(71) Applicant: Apple Inc., Cupertino, CA (US)

(72) Inventors: Daniel GRUBB, Santa Clara, CA (US); Ali SAZEGARI, Los Altos, CA (US); Tal ULIEL, Sunnyvale, CA (US); Rajdeep L. Bhuyar, San Jose, CA (US); Ran Aharon Chachick, Seattle, WA (US)

(21) Appl. No.: 19/052,786

(22) Filed: Feb. 13, 2025

Related U.S. Application Data
(60) Provisional application No. 63/556,271, filed on Feb. 21, 2024.

(51) Int. Cl. G06F 9/30

(52) U.S. Cl. CPC G06F 9/30098; G06F 9/3001; G06F 9/30036

(57) ABSTRACT

A computer system that can execute a sparse matrix instruction is disclosed. The computer system includes a processor circuit that may retrieve, in response to receiving an instruction, an input matrix and a weight matrix. The input matrix may include multiple input vectors, and the weight matrix may include multiple weight vectors, where a number of zero elements in the weight vector exceeds a threshold value. The processor circuit may generate a packed weight vector that includes an orthogonal subset of the plurality of weight vectors. A computation engine may perform, in parallel, a plurality of computations using a subset of the plurality of input vectors corresponding to the subset of the plurality of weight vectors included in the packed weight vector.

### CROSS-REFERENCE TO RELATED APPLICATIONS

The present application claims the benefit of U.S. Provisional Application No. 63/556,271, entitled “COMPUTATION ENGINE WITH SPARSE MATRIX INSTRUCTION,” filed Feb. 21, 2024, the content of which is incorporated by reference herein in its entirety for all purposes.

### FIELD

The described embodiments relate generally to computation engines that assist processor circuits and, more particularly, to computation engines that can perform computations in parallel.

### BACKGROUND

Many applications performed by computer systems include performing a large number of computations on relatively small numbers. For example, certain long short term (“LSTM”) learning algorithms are used in a variety of contexts such as language detection, card readers, natural language processing, handwriting processing, and machine learning, among other things. LSTM processing includes numerous multiply-and-accumulate operations.

General-purpose processor circuits, e.g., central processing units (“CPUs”), tend to exhibit low performance on the types of workloads described above. Even in processor circuits that include vector instructions, CPU performance remains limited and power consumption high. Low performance, high-power workloads are problematic for any computer system, but are especially problematic for computer systems that rely on batteries, such as smartphones, tablets, mobile computers, and the like.

### BRIEF DESCRIPTION OF THE DRAWINGS

FIG. 1 is a block diagram depicting an embodiment of a computer system.

FIG. 2 is a block diagram depicting an embodiment of a computation engine.

FIG. 3A is a block diagram depicting an embodiment of a compute circuit.

FIG. 3B is a block diagram depicting an embodiment of a compute element.

FIG. 4 is a block diagram depicting the generation of a packed weight vector.

FIG. 5 is a block diagram depicting an embodiment of a different computation engine.

FIG. 6 is a block diagram of a computation engine that includes processing element groups.

FIG. 7 is a flow diagram of an embodiment of a method for operating a computer system that includes a computation engine.

FIG. 8 is a flow diagram of an embodiment of a different method for operating a computer system that includes a computation engine.

FIG. 9 is a block diagram of an embodiment of a device that includes a computation engine.

FIG. 10 is a block diagram of various embodiments of computer systems that may include processor circuits.

FIG. 11 illustrates an example of a non-transitory computer-readable storage medium that stores circuit design information.

### DETAILED DESCRIPTION

Some applications, e.g., language detection and processing, executed on computer systems can require numerous computations. In some cases, the computations can include vector computations such as vector multiplication (also referred to as “vector cross product”). In many computer systems, performance can be low while executing vector operations.

Low performance of a computer system resulting from some operations can result in user-visible latency. For example, in voice-recognition applications, the time required for the necessary computation to identify speech, remove noise, and the like, will be evident to the user as a delay while the computer is processing. In some cases, computations associated with forming a response that requires generating speech can also result in delay observable by the user.

In some cases, some of the vectors being operated upon during vector operations may be sparse vectors. As used herein, a sparse vector is a vector that includes a threshold number of elements whose value is zero (referred to as “zero elements”). The threshold number may be based on a size of the vector, desired performance of the system, or any other suitable metrics.

During vector multiplication, multiplying a non-sparse vector (referred to as a “dense vector”) by a sparse vector can include multiplication operations that generate nothing but zero elements corresponding to the zero elements in the sparse vector. Matrix multiplication circuits used to generate all of the zero elements are essentially unused since the outcome of multiplying a zero element is already known. As a result, the matrix multiplication circuits are underutilized during sparse computations, limiting performance and increasing power consumption.

The embodiments illustrated in the drawings and described below provide techniques for performing computations using dense and sparse vectors. By packing different sparse data vectors that correspond to different dense input vectors into a single packed vector, multiple computations using the different dense input vectors can be performed in parallel, thereby improving system performance.

A block diagram of an embodiment of a computer system is depicted. As illustrated, computer system 100 includes processor circuit 101, lower-level cache circuit 102, and computation engine 103.

Processor circuit 101 includes data cache circuit 108, instruction cache circuit 104, and pipeline 105, which includes pipeline stages 106A-106N. In various embodiments, pipeline stages 106A-106N may be coupled in series.

In various embodiments, processor circuit 101 is coupled to lower-level cache circuit 102 and computation engine 103. In some embodiments, computation engine 103 may be coupled to lower-level cache circuit 102 as well, and/or may be coupled to data cache circuit 108.

Processor circuit 101 may, in some embodiments, fetch instructions from main memory (not shown), and store the fetched instructions in instruction cache circuit 104. In various embodiments, processor circuit 101 may be configured to retrieve fetched instructions from instruction cache circuit 104, and process the retrieved instructions through pipeline 105. In various embodiments, instruction cache circuit 104 may be implemented as a static random-access memory (“SRAM”) circuit using any suitable cache line size and configuration, e.g., set associative, direct mapped, and the like.

When an instruction is retrieved from instruction cache circuit 104, it is processed through pipeline stages 106A-106N. As depicted, pipeline 105 is generalized and may, in various embodiments, include any level of complexity and performance enhancing features. For example, processor circuit 101 may be superscalar, and one or more of pipeline stages 106A-106N may be configured to process multiple instructions at the same time. Pipeline 105 may vary in length for different types of instructions. For example, arithmetic logic unit (“ALU”) instructions may have schedule, address generation, translation/cache access, data forwarding, and miss processing stages. In various embodiments, pipeline stages 106A-106N may include register renaming, prefetching, and the like.

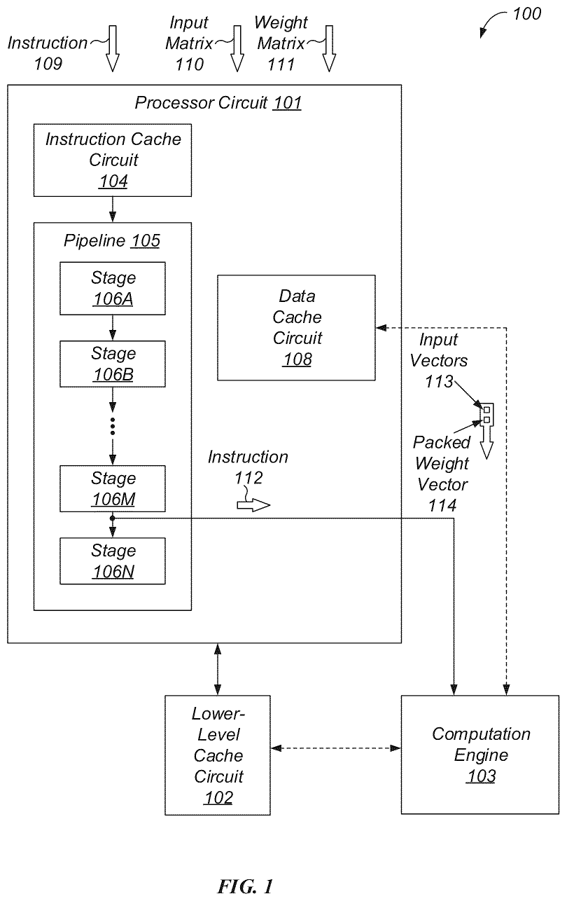

In various embodiments, processor circuit 101 may be configured to fetch various instructions intended for computation engine 103, e.g., instruction 109, and transmit the fetched instructions to computation engine 103 for execution. The overhead of the “front end” of processor circuit 101, i.e., fetching, decoding, etc., may be amortized over the computations performed by computation engine 103. In one embodiment, processor circuit 101 may be configured to propagate instructions through pipeline stages 106A-106N to the point at which the instructions becomes non-speculative. As depicted in FIG. 1, pipeline stage 106M is the non-speculative stage of pipeline 105. From pipeline stage 106M, instruction 112 is transmitted to computation engine 103. In various embodiments, processor circuit 101 may retrieve instruction 112 prior to computation engine 103 completing an associated computation. In other embodiments, processor circuit 101 may retire instruction 112 prior to computation engine 103 starting the associated computation in cases where instruction 112 is queued behind other instructions inside of computation engine 103.

Data cache circuit 108 is configured to store frequently accessed data for processor circuit 101 and computation engine 103. In various embodiments, data cache circuit 108 may be configured to store input vectors 113 and packed weight vector 114. In some cases, data cache circuit 108 may be further configured to store results from computation engine 103 prior to their storage back to main memory. In various embodiments, data cache circuit 108 may be implemented as a SRAM memory circuit using any suitable cache line size and configuration, e.g., set associative, direct mapped, and the like.

Lower-level cache circuit 102 is configured to store frequently fetched instructions. In various embodiments, if a previously fetched instruction is stored in lower-level cache circuit 102, processor circuit 101 may be configured to retrieve the previously fetched instruction from lower-level cache circuit 102 rather than requesting the previously fetched instruction from main memory. In some embodiments, computation engine 103 may also be configured to retrieve previously fetched instructions from lower-level cache circuit 102. In various embodiments, lower-level cache circuit 102 may be implemented as a SRAM memory using any suitable cache line size and configuration, e.g., set associative, direct mapped, and the like.

In various embodiments, computation engine 103 is configured to perform one or more computation operations. In some embodiments, computation engine 103 may be configured to employ an instruction set, which may be a subset of an instruction set of processor circuit 101. In such cases, processor circuit 101 may recognize instructions implemented by computation engine 103 and may communicate such instructions to computation engine 103.

Processor circuit 101 may, in some embodiments, be configured to retrieve instruction 109. In some cases, processor circuit 101 may be configured to retrieve instruction 109 from instruction cache circuit 104 or from main memory. In some embodiments, instruction 109 may be a “crossbar outer product and accumulate instruction.” A prototype call for such a crossbar outer product instruction is depicted in code snippet 1, where ZA is the destination tile, S is a datatype, Zm points to a register that includes the packed weight vector, Zn points to one or more registers containing input vectors, e.g., input vectors 113, and Zk points to a register that includes the selection vector (also referred to as a “lookup table”). Pseudocode for the crossbar outer product and accumulate instruction is depicted in Appendix A.

Code Snippet 1—Prototype Call for Crossbar Outer Product and Accumulate Instruction
XBAROPA ZA.S, Zn.S, Zm.S, Zk.S

In various embodiments, processor circuit 101 is configured, in response to executing instruction 109, to retrieve input matrix 110 and weight matrix 111. In various embodiments, input matrix 110 includes input vectors 113, and weight matrix 111 includes multiple weight vectors. In some embodiments, weight matrix 111 may be a sparse matrix, i.e., a number of zero elements included in weight matrix 111 may be greater than a threshold value. In various embodiments, input matrix 110 and weight matrix 111 may be stored in main memory. Alternatively, respective copies of input matrix 110 and weight matrix 111 may be stored in data cache circuit 108.

Processor circuit 101 may be additionally configured, in response to executing instruction 109, to generate packed weight vector 114. In various embodiments, packed weight vector 114 includes an orthogonal subset of the weight vectors included in weight matrix 111. As used herein, an orthogonal subset of a set of vectors is a subset where a vector dot product of any two vectors in the subset is zero.

Computation engine 103 is configured to perform, in parallel, a plurality of computations using a subset of input vectors 113 corresponding to the subset of vectors included in packed weight vector 114. In some cases, computation engine 103 may be configured to perform the plurality of computations based on the execution of instruction 109. In various embodiments, computation engine 103 may be configured to retrieve input vectors 113 and packed weight vector 114 from data cache circuit 108. Alternatively, or additionally, computation engine 103 may be configured to retrieve input vectors 113 and/or packed weight vector 114 from main memory or lower-level cache circuit 102.

In other embodiments, processor circuit 101 may be configured to generate instruction 112 based on instruction 109, and computation engine 103 may be configured to perform the plurality of computations in response to receiving instruction 112 from pipeline 105 of processor circuit 101. It is noted that, in some embodiments, instruction 112 may be the same as instruction 109 while, in other embodiments, various ones of pipeline stages 106A-106N may make changes to instruction 109 to generate instruction 112.

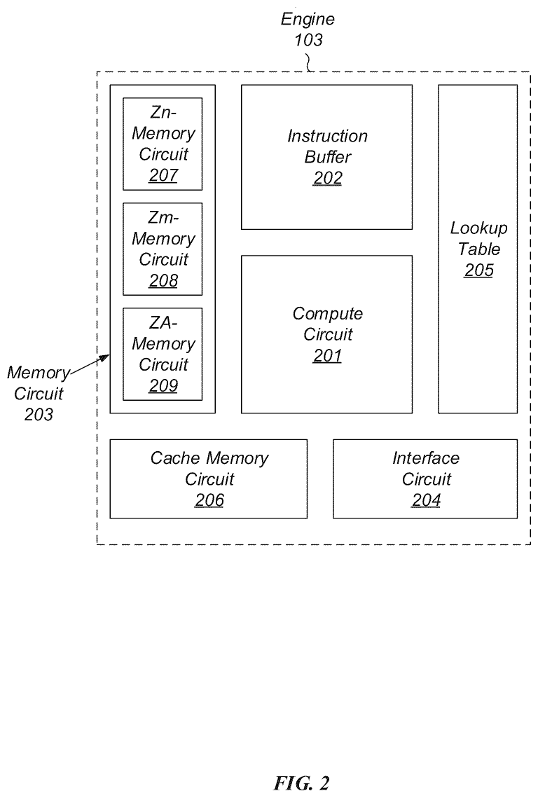

Turning to FIG. 2, a block diagram of computation engine 103 is depicted. As illustrated, computation engine 103 includes compute circuit 201, instruction buffer 202, memory circuit 203, interface circuit 204, lookup table 205, and cache memory circuit 206.

Compute circuit 201 is configured to perform, in parallel, a plurality of computations using a subset of input vectors 113 corresponding to the subset of a plurality of weight vectors included in packed weight vector 114. In various embodiments, the plurality of computations may include vector multiplication. In some embodiments, compute circuit 201 may, in response to receiving instruction 112 via interface circuit 204, retrieve the subset of input vectors 113 and packed weight vector 114 from memory circuit 203 prior to performing the plurality of computations. As described below, compute circuit 201 may include multiple compute elements that are configured to perform respective portions of the plurality of computations.

Lookup table 205 is configured to store information that maps weights included in packed weight vector 114 to particular ones of input vectors 113. In various embodiments, to perform a computation, compute circuit 201 is configured to retrieve the information from lookup table 205 and use the information to select particular ones of input vectors 113 upon which to operate. Lookup table 205 may, in some embodiments, be implemented using a SRAM memory circuit, a register file circuit, or any suitable combination of flip-flop and/or latch circuits.

Interface circuit 204 is configured to relay information between computation engine 103 and processor circuit 101. In various embodiments, interface circuit 204 may relay instruction 112 from pipeline 105 to instruction buffer 202. Additionally, interface circuit 204 may relay input vectors 113 and packed weight vector 114 from data cache circuit 108 to memory circuit 203.

Instruction buffer 202 is configured to receive instructions via interface circuit 204. In some embodiments, instruction buffer 202 may be configured to communicate with processor circuit 101 via the interface of interface circuit 204 to indicate acceptance of instructions, requests for instructions, etc. In various embodiments, instruction buffer 202 may be configured to queue instructions while other instructions are being performed. Instruction buffer 202 may, in other embodiments, be configured to perform out-of-order processing of instructions. In some embodiments, instruction buffer 202 may be implemented using a first-in/first-out (FIFO) buffer circuit, or any other suitable type of buffer circuit.

Memory circuit 203 includes Zn-memory circuit 207, Zm-memory circuit 208, and ZA-memory circuit 209, each of which may be configured to store data received from processor circuit 101 as well as accumulated data generated by compute circuit 201 in response to performing computation operations. For example, Zn-memory circuit 207 may store input vectors 113, and Zm-memory circuit 208 may store packed weight vector 114, as well as intermediate and final results from performing a computation such as a multiply-and-accumulate operation. It is noted that, in some embodiments, Zn-memory circuit 207 may be referred to as a y-memory circuit, Zm-memory circuit 208 may be referred to as an x-memory circuit, and ZA-memory circuit 209 may be referred to as a z-memory circuit. In various embodiments, memory circuit 203 may be implemented using a SRAM circuit, or any other suitable storage circuit.

As described below, compute circuit 201 may include multiple compute elements disposed in an array of rows and columns. In various embodiments, a given one of the multiple compute elements may receive selected elements from Zn-memory circuit 207 and Zm-memory circuit 208, and multiply such received elements. In some embodiments, a given compute element may receive a current value of a destination location in ZA-memory circuit 209 and may sum the current value with a result of the multiplication to generate a result to be stored in ZA-memory circuit 209 (thus accumulating the multiplication result with previous results).

In matrix mode, each vector element from Zn-memory circuit 207 is multiplied by each of the vector elements from Zm-memory circuit 208 to generate matrix elements for an output matrix. Specifically, input vectors may be loaded into Zn-memory circuit 207 and Zm-memory circuit 208, and a compute instruction may be executed by computation engine 103. In response to the compute instructions (and particularly the compute instruction for the matrix mode), computation engine 103 may be configured to perform the outer product operation and write a resulting outer product matrix to ZA-memory circuit 209. If the vector loaded into Zn-memory circuit 207 has a first number of vector elements and the vector loaded into Zm-memory circuit 208 has a second number of vector elements, then the resulting matrix (element i, j) is the product of corresponding vector elements X(i) and Y(j). In an embodiment, the first number of vector elements is equal to the second number of matrix elements, resulting in a square output matrix. Other embodiments may implement non-square matrices, or different outer product operations may product square or non-square results based on the input vector elements.

In an embodiment, computation engine 103 may be configured to perform output product operations along with accumulating the result matrix with previous results in ZA-memory circuit 209 (where the accumulation may be by adding or subtracting). That is, the outer product instruction may be a fused multiply-add (FMA) operation defined to multiply elements of a vector stored in Zn-memory circuit 207 (a “x-vector”) by elements of a vector stored in Zm-memory circuit 208 (a “y-vector”) and add the products to corresponding elements of a matrix stored in ZA-memory circuit 209 (a “z-matrix”), or may be a fused multiply-subtract (FMS) operation defined to multiply elements of the x-vector by elements of the y-vector and subtract the products from corresponding elements of the z-matrix. Alternatively, the FMS operation may include subtracting the corresponding elements of the z-matrix from the products. In an embodiment, the FMA and FMS operations may operate on floating-point vector elements. A multiply-and-accumulate (MAC) compute instruction may also be supported for integer vector elements.

Furthermore, the computation instructions (FMA, FMS, and MAC) may be code for a vector mode. In the vector mode, a vector multiplication may be performed (e.g., each vector element in one vector may be multiplied by the corresponding vector elements in the other vector). The results may be accumulated with current values stored in ZA-memory circuit 209 at a targeted entry of ZA-memory circuit 209. That is, in vector mode, a single entry (or row) stored in ZA-memory circuit 209 may be updated in vector mode, as opposed to multiple entries (or rows), representing a matrix in matrix mode.

Additionally, computation engine 103 may be configured to read operands from any offset within Zn-memory circuit 207 and/or Zm-memory circuit 208. The operands may be selected with a register address identifying the entry in memory circuits from which operands are to be read, and an offset into that entry. The initial operand element (vector element) may be selected from the offset, and additional vector elements may be read from adjacent locations in the entry until the end of the entry is reached. Computation engine 103 may be configured to complete the vector by reading additional vector elements from the beginning of a next entry (the register address plus one). Thus, the data to be operated upon may be “misaligned” in the entries, and the correct data for a given operation may be read without moving data around in Zn-memory circuit 207 and Zm-memory circuit 208. Such an operation may be useful in situations where the operations to be performed use partially overlapping data.

In an embodiment, the vector elements may be 8 or 16 bit integers of 16, 32 or 64 bit floating point numbers. Thus, a 64-bit field in Zn-memory circuit 207 or in Zm-memory circuit 208 may include four 16-bit integers or eight 8-bit integers. Similarly, a 64-bit field in Zn-memory circuit 207 or Zm-memory circuit 208 may include four 16-bit floating-point numbers, two 32-bit floating-point numbers, or one 64-bit floating-point number.

As previously mentioned, compute circuit 201 may be implemented as an array of compute elements, not only to perform the multiplication and addition operations that generate the elements for one result matrix element or result vector element, but also to perform multiplication and addition operations for matrix/vector operations in parallel. For example, if Zn-memory circuit 207 and Zm-memory circuit 208 include 512-bit entries and 8-bit vector elements are implemented, 64 vector elements input matrices are stored in each entry stored in Zn-memory circuit 207 and Zm-memory circuit 208 and may be processed in parallel in response to one compute instruction. Similarly, if 1024-bit entries are supported per entry of the memory circuits, 128 vector elements may be processed in parallel. If 128-bit entries are supported, 16 vector elements may be processed in parallel. If 256 bit entries are supported, 32 vector elements may be processed in parallel. Alternatively, compute circuit 201 may include a smaller number of MACs than would be used to perform all of the matrix/vector element multiplications in the input operands in parallel. In such an embodiment, computation engine 103 may use multiple passes through compute circuit 201 for different portions of input data from Zn-memory circuit 207 and Zm-memory circuit 208 to complete one array of matrix computations.

As mentioned above, computation engine 103 may support multiple sizes of matrix/vector elements in the accumulated results. For example, 16-bit result elements and 32-bit result elements may be supported for 16-bit input elements. For 32-bit input elements, 32-bit or 64-bit elements may be supported. The maximum number of result elements in ZA-memory circuit 209 may be set by the size of ZA-memory circuit 209 and the size of the accumulated elements for a given operation. Smaller sizes may consume less memory in ZA-memory circuit 209. For matrix operations, ZA-memory circuit 209 may be arranged to write the smaller matrix elements in certain entries of ZA-memory circuit 209, leaving other entries unused (or unmodified). For example, if the matrix elements are ½ the size of the largest element, every other entry in ZA-memory circuit 209 may be unused. If the matrix elements are ¼ the maximum size element, every fourth row may be used, etc. In an embodiments, ZA-memory circuit 209 may be viewed as having multiple banks, where the entries in ZA-memory circuit 209 are spread across the banks (e.g., even addressed entries may in bank 0, and odd addressed entries may be in bank 1, for a two-bank implementation). Every fourth entry may be in a different bank if there are four banks (e.g., entries 0, 4, 8, etc., may be in bank 0, entries 1, 5, 9, etc., may be in bank 1, and so forth). Vector results may consume one row in ZA-memory circuit 209.

In some embodiments, the instructions executed by computation engine 103 may also include memory instructions (e.g., load/store instructions). The load instructions may transfer vectors/matrices from a system memory (not shown) to Zn-memory circuit 207, Zm-memory circuit 208, or ZA-memory circuit 209. The store instructions may write the matrices/vectors from ZA-memory circuit 209 to the system memory. Some embodiments may also include store instructions to write vectors/matrices from Zn-memory circuit 207 and Zm-memory circuit 208 to the system memory. The system memory may be a memory accessed at a bottom of a cache hierarchy that includes instruction cache circuit 104, data cache circuit 108, and lower-level cache circuit 102. The system memory may be implemented using static random-access memory (SRAM) circuits, dynamic random-access memory (DRAM) circuits, or any other suitable type of memory circuit. A memory controller circuit may also be included to interface to the system memory. In an embodiment, computation engine 103 may be cache coherent with processor circuit 101, and may have access to data cache circuit 108 to read/write data. Alternatively, computation engine 103 may have access to lower-level cache circuit 102 instead, and lower-level cache circuit 102 may ensure cache coherency with data cache circuit 108. In other embodiments, computation engine 103 may have access to the memory system, and a coherence point in the memory system may ensure the coherency of the accesses.

Cache memory circuit 206 may be configured to store data recently accessed by computation engine 103. In various embodiments, the inclusion of cache memory circuit 206, as well as the size of cache memory circuit 206, may be based on an effective latency experienced by computation engine 103 and a desired level of performance of computation engine 103. In various embodiments, cache memory circuit 206 may be implemented using any suitable cache line size and configuration, e.g., set associative, direct mapped, and the like.

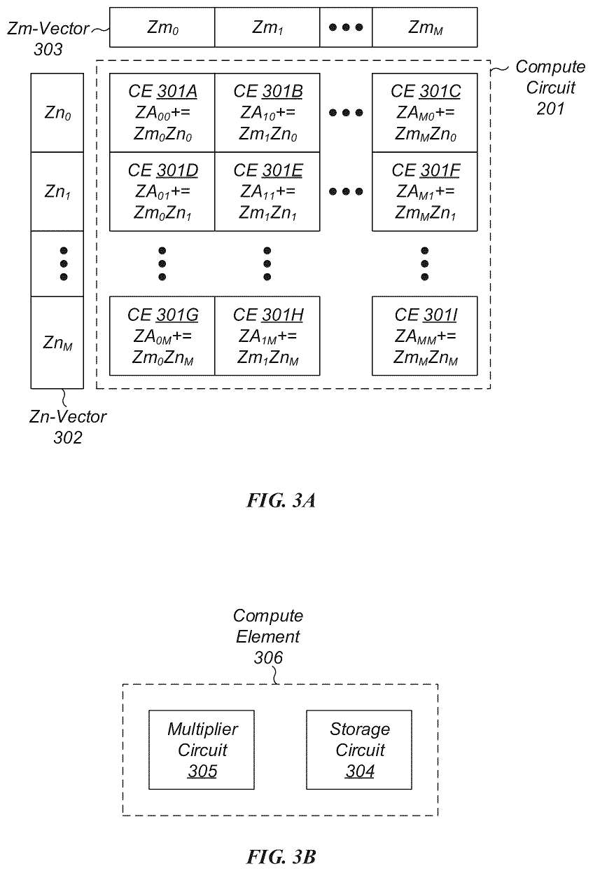

Turning to FIG. 3A, a block diagram of an embodiment of compute circuit 201 is depicted. As illustrated, compute circuit 201 includes compute elements (denoted as “CE 301A-301I”). Although only 9 compute elements are depicted in the embodiment of FIG. 3A, in other embodiments, any suitable number of compute elements may be employed. In some embodiments, the number of compute elements may be based on the size of vectors to be operated on by compute circuit 201. For example, in the case of a vector multiplication of two 8-bit vectors, compute circuit 201 will include 64 compute elements.

In various embodiments, CEs 301A-301I may be coupled together in an array and may be configured to perform various operations, e.g., multiply-and-accumulate operations. In other embodiments, CEs 301A-301I may be configured to perform other mathematical operations, e.g., addition. CEs 301A-301I may be configured to receive Zn-vector 302 and Zm-vector 303, which may be stored in Zn-memory circuit 207 and Zm-memory circuit 208, respectively. In some embodiments, CEs 301A-301I may be further configured to perform accumulation operations in ZA-memory circuit 209 and/or cache memory circuit 206.

The elements of Zn-vector 302 are labeled Zn₀ to Zn_{M}, and the elements of Zm-vector 303 are labeled Zm₀ to Zm_{M}. Elements of the resultant matrix are labeled ZA₀₀ to ZA_{MM} and may, in some embodiments, be stored in ZA-memory circuit 209. As illustrated, the first digit of the matrix element is the number of the element from Zn-vector 302, and the second digit of the matrix element is the number of the corresponding element from Zm-vector 303. Thus, each row of compute circuit 201 corresponds to a particular element of Zm-vector 303, and each column of compute circuit 201 corresponds to a particular element of Zn-vector 302. Each compute element of CEs 301A-301I may operate on corresponding elements of Zn-vector 302 and Zm-vector 303 to generate a corresponding one of matrix elements ZA₀₀ to ZA_{MM}. For example, CE 301A can be configured to generate a product of Zn₀ and Zm₀ which is added to an existing value for ZA₀₀.

In various embodiments, computation engine 103 may be configured to support various instructions such as fused-multiply-add (FMA), fused-multiply-subtract (FMS), multiply-and-accumulate (MAC), or any other suitable instructions. FMA and FMS may operate on floating-point elements (e.g., 16-bit, 32-bit, or 64-bit elements). FMA may compute ZA=ZA+Zn*Zm, where FMS may compute ZA=ZA−Zn*Zm. MAC may operate on integer operands (e.g., 8-bit, 16-bit integer operands) and may compute ZA=ZA+Zn*Zm. In some embodiments, MAC may support an optional right shift of the multiplication result before accumulating the result with ZA.

Turning to FIG. 3B, a block diagram of an embodiment of a compute element is depicted. As illustrated, compute element 306 includes multiplier circuit 305 and storage circuit 304. In various embodiments, compute element 306 may correspond to any of CEs 301A-301D as depicted in the embodiment of FIG. 3A.

Multiplier circuit 305 is configured to multiply two numbers. In various embodiments, one of the numbers may be a portion of one of input vectors 113, while the other number may be a portion of packed weight vector 114. In some cases, multiplier circuit 305 may be configured to support both integer and floating-point multiplication operations. In some embodiments, the two numbers may be in a binary format, 2's-complement format, or any other suitable format. In various embodiments, multiplier circuit 305 may be implemented using a Wallace tree multiplier circuit, a Booth multiplier circuit, or any other suitable type of multiplier circuit.

Storage circuit 304 is configured to store at least one of either the multiplicand or the multiplier prior to a multiplication operation performed by multiplier circuit 305. In some embodiments, storage circuit 304 may be further configured to store a product of the multiplication operation performed by multiplier circuit 305 to allow for accumulation operations. In various embodiments, storage circuit 304 may be implemented using a SRAM circuit, one or more register file circuits that include multiple flip-flop or latch circuits, or any other suitable circuit configured to store multiple bits of data.

Although only two circuits are depicted in compute element 306, in other embodiments, the inclusion of other circuit blocks is possible and contemplated. For example, in some embodiments, compute element 306 may include addition circuits, subtraction circuits, division circuits, and the like.

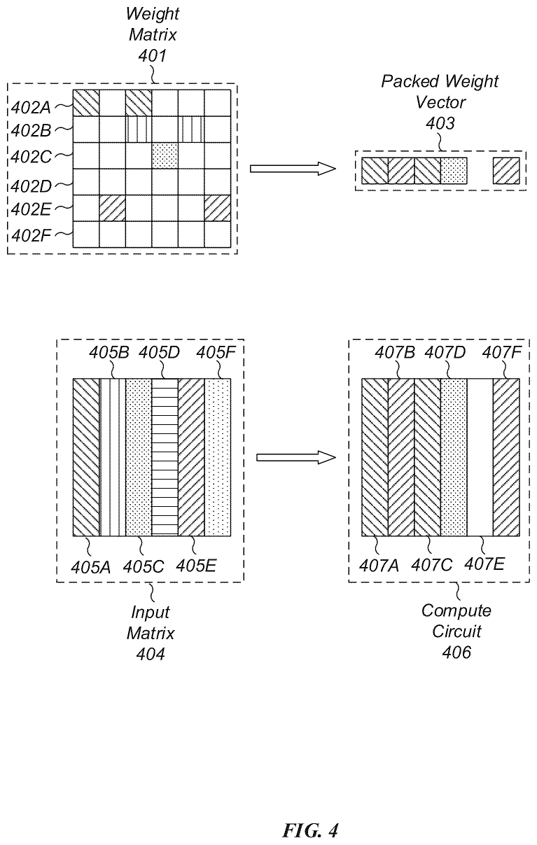

Turning to FIG. 4, a block diagram depicting the generation of a packed weight vector is illustrated. In various embodiments, the generation of the packed weight vector may be in response to execution of instruction 109 by processor circuit 101, or may be in response to the execution of one or more instructions fetched prior to instruction 109 by processor circuit 101.

Weight matrix 401, which may, in various embodiments, correspond to weight matrix 111 as depicted in FIG. 1, includes weight vectors 402A-402F. As illustrated, weight vector 402A includes two non-zero elements (zero elements are depicted as squares with no fill pattern). In a similar fashion, weight vectors 402B and 402E also include two non-zero elements, while weight vector 402C includes only one non-zero element. Weight vectors 402D and 402F include nothing but zero elements. In various embodiments, a number of zero elements in weight matrix 401 is greater than a threshold value, making weight matrix 401 a sparse matrix.

It is noted that although the vectors included in weight matrix 401 are depicted as having 6 elements, in other embodiments, the vectors included in weight matrix 401 may include any suitable number of elements. It is further noted that although weight matrix 401 includes 6 vectors, in other embodiments, weight matrix 401 may include any suitable number of vectors.

The respective positions of non-zero elements of weight vectors 402A, 402C, and 402E do not overlap, i.e., the vector dot product between any two of weight vectors 402A, 402C, and 402E is zero, making the vectors orthogonal. Since weight vectors 402A, 402C, and 402E are orthogonal, they can be combined (or “packed”) into packed weight vector 403. It is noted that, in various embodiments, packed weight vector 403 may correspond to packed weight vector 114 as depicted in FIG. 1.

In cases where the weight vectors are not orthogonal, portions or subsets of different weight vectors may be combined to form a packed weight vector such as packed weight vector 403. In some embodiments, different subsets of a given weight vector may be used to form corresponding packed weight vectors along with subsets of other weight vectors. By allowing the use of different subsets of weight vectors to be used in the formation of packed weight vectors, the sparse computation techniques described herein may be employed in cases where a weight matrix includes no orthogonal vectors or a small number of orthogonal vectors.

Input matrix 404 includes input vectors 405A-405F. In various embodiments, input matrix 404 and input vectors 405A-405F may correspond to input matrix 110 and weight matrix 111, respectively. Vector cross product operations are to be performed between ones of input vectors 405A-405F and corresponding ones of weight vectors 402A-402F as noted by common fill patterns in FIG. 4. For example, a vector cross product operation is to be performed using input vector 405A and weight vectors 402A. In a similar fashion, a vector cross product operation is to be performed using input vector 405B and weight vector 402B.

Using packed weight vector 403, compute circuit 406 can dedicate different sets of compute elements 407A-407F to different ones of multiple vector cross product operations. As illustrated, compute elements 407A and 407C are used to compute the vector cross product of input vector 405A and weight vector 402A, while compute elements 407B and 407F are used to compute the vector cross product of input vector 405E and weight vector 402E. In a similar fashion, compute elements 407D are used to compute the vector cross product of input vector 405C and weight vector 402C. It is noted that compute elements 407E are unused. By mapping different compute elements to different input vectors based on packed weight vector 403, the vector cross product operations described above can be performed in parallel, saving compute cycles and power. If packed weight vector 403 is not employed, the vector cross products described above would have to be performed serially, with larger numbers of compute elements 407A-407F being unused.

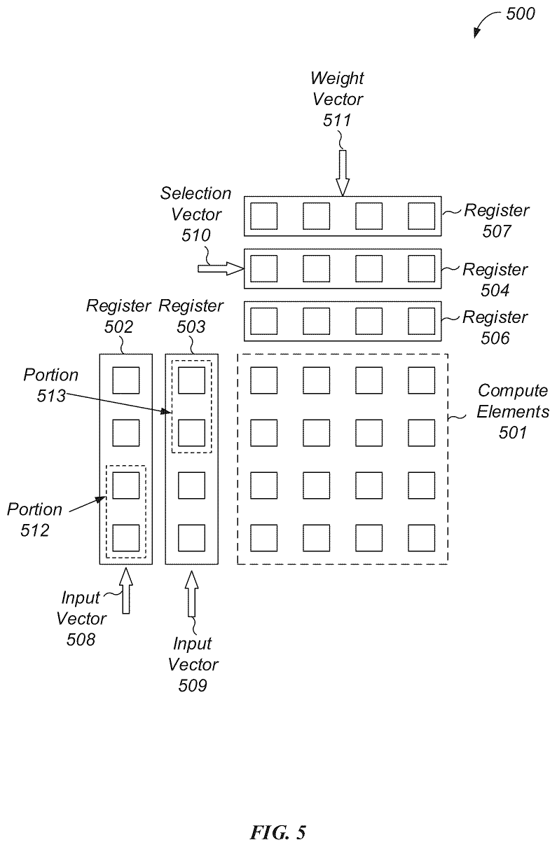

Turning to FIG. 5, a block diagram of an embodiment of a different computation engine is depicted. As illustrated, computation engine 500 includes compute elements 501 and register circuits 502-507. It is noted that, in various embodiments, computation engine 500 may correspond to computation engine 103 as depicted in FIG. 1.

Although compute elements 501 is depicted as included 16 compute circuits, in other embodiments, compute elements 501 may include any suitable number of compute circuits. In various embodiments, any of compute elements 501 may correspond to compute element 306 as depicted in FIG. 3B.

Register circuit 502 can be configured to store input vector 508, and register circuit 503 can be configured to store input vector 509. In various embodiments, input vector 508 and input vector 509 may be included in input matrix 110. It is noted that, in some embodiments, computation engine 500 can be configured to reorder or encode the respective elements included in input vectors 508 and 509 in order to consolidate sparse versus non-sparse portions of the vectors.

Register 504 can be configured to store selection vector 510. In various embodiments, computation engine 500 may be configured to use selection vector 510 to determine which portions of input vector 508 and input vector 509 are used in a computation. For example, selection vector 510 may indicate that portion 512 of input vector 508, and portion 513 of input vector 509 are to be used in a particular computation. In some embodiments, elements of selection vector 510 may be reordered to aid in the selection of non-sparse portions of input vector 508 and input vector 509.

In various embodiments, registers 502-503 may be included in Zn-memory circuit 207. In some cases, different ones of registers 502-503 may correspond to different entries, address ranges, or banks within Zn-memory circuit 207.

Register 507 can be configured to store weight vector 511. In various embodiments, weight vector 511 may be included in weight matrix 111. In some embodiments, register 506 may be configured to store predicate information, lookup table information, or any other suitable information that computation engine 500 may employ in performing a computation. In various embodiments, registers 504, 506 and 507 may be included in Zm-memory circuit 208. In some cases, registers 504, 506 and 507 may correspond to different entries, address locations, or banks within Zm-memory circuit 208.

Compute elements 501 may correspond to CEs 301A-301I as depicted in FIG. 3A. As described below, compute elements 501 may be coupled to multiple communication buses for receiving data from registers 502-507, and for sending or receiving data from ZA-memory circuit 209.

As described above, elements from different ones of portion 512 and portion 513 may be transferred to corresponding ones of compute elements 501. Additionally, different elements of weight vector 511 may be transferred to corresponding ones of compute elements 501. Once elements have been transferred to different ones of compute elements 501, an operation may be performed with the different ones of compute elements 501 performing, in parallel, respective parts of the operation.

It is noted that, in some cases, one or more of compute elements 501 may not receive elements from either input vectors 508 or 509, or weight vector 511 if the data the one or more of compute elements 501 is to receive is sparse data. In such cases, the one or more of compute elements 501 may be deactivated when the operation is to be performed. By deactivating unused compute elements, the power consumption of computation engine 500 may be reduced.

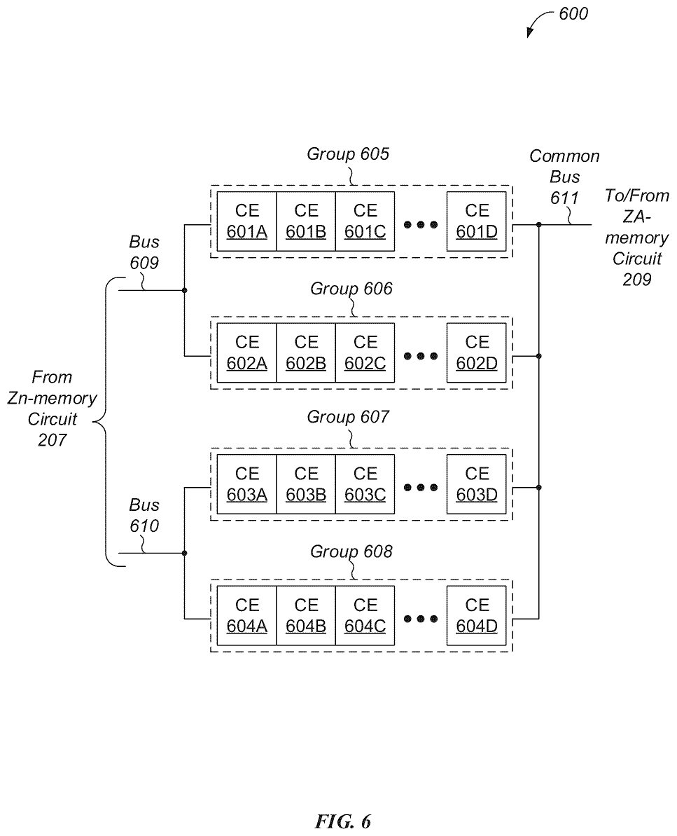

Turning to FIG. 6, a block diagram of a computation engine that includes processing element groups is depicted. As illustrated, computation engine 600 includes compute elements (also referred to as “processing elements”) denoted as CE 601A-601D, CE 602A-602D, CE 603A-603D, and CE 604A-604D organized into different groups (also referred to as “processing element groups” or “pegs”). For example, CE 601A-601D are included in group 605, CE 602A-602D are included in group 606, and so on. Although rows of CEs are organized into corresponding groups, in other embodiments, different arrangements, e.g., two rows of CEs included in a single group, are possible and contemplated.

Each of groups 605-608 are connected to common bus 611. In various embodiments, common bus 611 may be used to allow individual CEs included in groups 605-608 to send data to or receive data from ZA-memory circuit 209. In various embodiments, common bus 611 may be 512-bits wide or any other suitable bit width.

The different CEs are connected to Zn-memory circuit 207 through a group of buses. As above, the group of buses may be of any suitable bit width. In various embodiments, there are less buses than there are rows in a compute circuit such as compute circuit 201. As such, a given bus may be mapped to more than one group of CEs. For example, bus 609 is mapped to group 605 and group 606. In a similar fashion, bus 610 is mapped to group 607 and group 608. In other words, a group of CEs may share a bus for receiving data from Zn-memory circuit 207. Although two groups of CEs are shown coupled to a shared bus, in other embodiments, different numbers of groups, e.g., four groups of CEs, may be coupled to a single shared bus. The number of CE groups coupled to a shared bus may depend on a size of compute circuit 201, a number of elements in Zn-vector 302 and Zm-vector 303, or any other suitable parameter of computation engine 103.

Since a given bus connected between ZA-memory circuit 209 and compute circuit 201 may be coupled to multiple groups of CEs, data may be sent from ZA-memory circuit 209 to different ones of the groups of CEs using multiple passes. In a first pass a first set of elements from a vector(s) stored in ZA-memory circuit 209 are transferred to a first set of CEs included in the group of CEs coupled to the shared bus. In a second pass, a second set of elements from the vector(s) are transferred to a second set of CEs included in the group of CEs, and so forth.

To summarize, various embodiments of a computer system are disclosed. Broadly speaking, a computer system may include a plurality of register circuits and a computation engine. The plurality of register circuits may be configured to store corresponding vectors of a plurality of vectors. The computation engine may include a plurality of compute circuits disposed in an array of rows and columns. The computation engine may be configured to select a first portion of a first input vector from a first register circuit of the plurality of register circuits using a selection vector stored in a particular register circuit of the plurality of register circuits. The computation engine may be further configured to select, using the selection vector, a second portion of the second input vector from a second register circuit of the plurality of register circuits. Additionally, the computation engine may be configured to perform, in parallel, using the plurality of compute circuits, a plurality of computations using the first portion of the first input vector, the second portion of the second input vector, and a weight vector. In some cases, the plurality of computations are included in a vector outer product computation, and the weight vector is stored in a different register circuit of the plurality of register circuits.

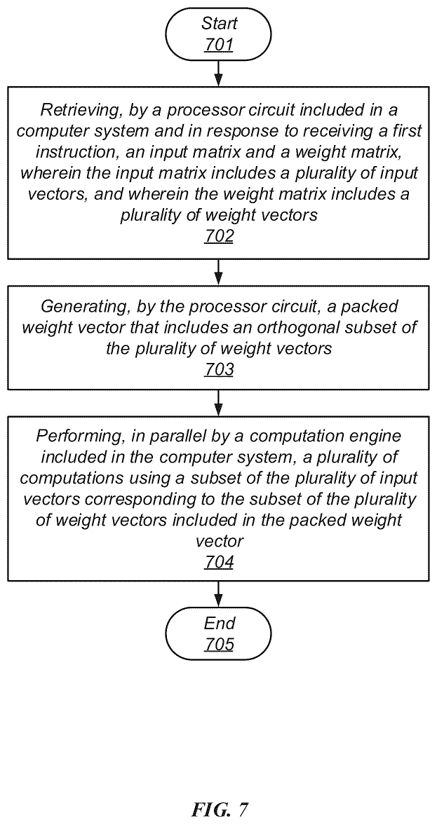

Turning to FIG. 7, a flow diagram depicting an embodiment of a method for operating a computation engine included in a processor circuit is depicted. The method, which may be applied to various computer systems, e.g., computer system 100, begins in block 701.

The method includes retrieving, by a processor circuit included in a computer system and in response to receiving a first instruction, an input matrix and a weight matrix (block 702). In various embodiments, the input matrix includes a plurality of input vectors, and the weight matrix includes a plurality of weight vectors. In some embodiments, a number of zero elements included in the weight matrix exceeds a threshold value.

The method further includes generating, by the processor circuit, a packed weight vector that includes an orthogonal subset of the plurality of weight vectors (block 703). In some embodiments, generating the packed weight vector includes storing, by the processor circuit, information in a lookup table. In such cases, the information maps particular weights included in the subset of the plurality of weight vectors to corresponding input vectors of the subset of the plurality of input vectors.

The method also includes performing, in parallel by a computation engine included in the computer system, a plurality of computations using a subset of the plurality of input vectors corresponding to the subset of the plurality of weight vectors included in the packed weight vector (block 704). In some embodiments, the plurality of computations includes a respective plurality of vector multiplication operations.

In some embodiments, the method may include generating, by the processor circuit, a second instruction using the first instruction, and sending, by the processor circuit, the second instruction to the computation engine. In such cases, the method may additionally include performing, by the computation engine, the plurality of computations in response to the computation engine receiving the second instruction. In various embodiments, performing the plurality of computations can include retrieving, by the computation engine, the information from the lookup table. The method concludes in block 705.

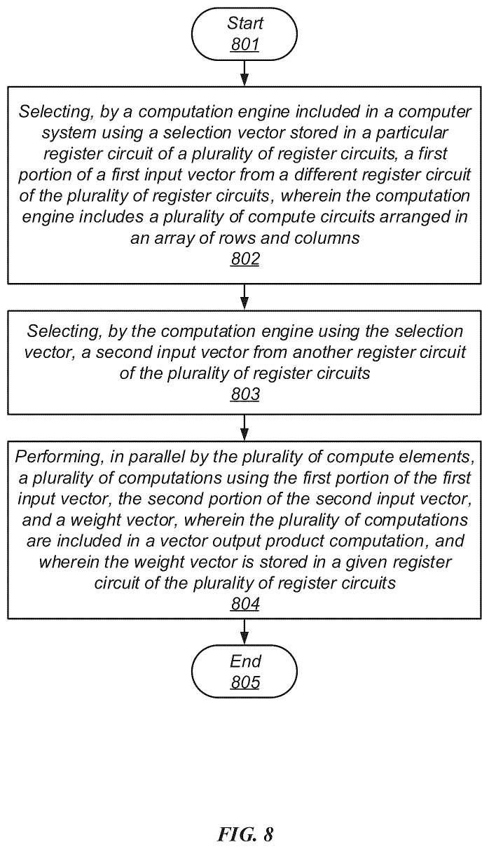

Turning to FIG. 8, a flow diagram depicting an embodiment of a different method for operating a computation engine included in a processor circuit is depicted. The method, which may be applied to various computer systems, e.g., computer system 100, begins in block 801.

The method includes selecting, by a computation engine included in a computer system using a selection vector stored in a particular register circuit of a plurality of register circuits, a first portion of a first input vector from a different register circuit of the plurality of register circuits (block 802). In various embodiments, the computation engine includes a plurality of compute circuits arranged in an array of rows and columns. In some embodiments, a particular row of compute circuits of the plurality of compute circuits may be coupled to a first communication bus. In a similar fashion, a different row of compute circuits of the plurality of compute circuits may be coupled to a second communication bus. Although it is described as various rows of the array of compute elements being coupled to corresponding communication buses, in other embodiments, any suitable group of subsets of compute elements of the array of compute elements may be coupled to corresponding communication buses.

The method further includes selecting, by the computation engine using the selection vector, a second portion of a second input vector from a different register circuit of the plurality of register circuits (block 803).

In some embodiments, the method may additionally include transferring, by the computation engine using the first communication bus, a particular element of the first portion of the first input vector to a corresponding compute circuit included in the particular row of compute circuits. Moreover, the method may include transferring, by the computation engine using the second communication bus, a different element of the first portion of the first input vector to a corresponding compute circuit included in the different row of compute circuits. It is noted that elements of the second portion of the second input vector may be transferred to corresponding compute elements in a similar fashion.

In some cases, the first portion of the first input vector and the second portion of the second input vector may be “dense” sub-vectors. In other words, a first number of zeros included in the first portion of the first input vector may be less than a threshold value, and a second number of zeros included in the second portion of the second input vector may be less than the threshold value. In other embodiments, the weight vector may be included in a weight matrix, where a number of zero elements included in the weight matrix exceeds a different threshold value.

The method also includes performing, in parallel by the plurality of compute elements, a plurality of computations using the first portion of the first input vector, the second portion of the second input vector, and a weight vector (block 804). In various embodiments, the plurality of computations are included in a vector outer product computation, and the weight vector is stored in a fourth register circuit of the plurality of register circuits.

In some cases, performing the plurality of computations includes performing respective operations of a plurality of operations using a particular element of the first portion of the first input vector and corresponding elements of the weight vector. In various embodiments, a given computation of the plurality of computations may include a multiply-and-accumulate operation. The method concludes in block 805.

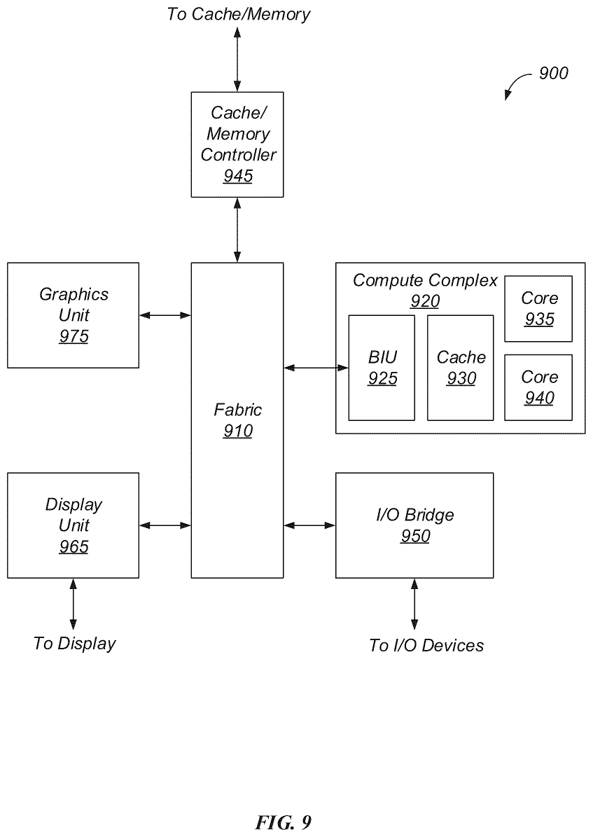

Referring now to FIG. 9, a block diagram illustrating an example embodiment of a device that includes a processor circuit that employs out-of-order completion is shown. In some embodiments, elements of device 900 may be included within a system on a chip. In some embodiments, device 900 may be included in a mobile device, which may be battery-powered. Therefore, power consumption by device 900 may be an important design consideration. In the illustrated embodiment, device 900 includes fabric 910, compute complex 920, input/output (I/O) bridge 950, cache/memory controller 945, graphics unit 975, and display unit 965. In some embodiments, device 900 may include other components (not shown) in addition to, or in place of, the illustrated components, such as video processor encoders and decoders, image processing or recognition elements, computer vision elements, etc.

Fabric 910 may include various interconnects, buses, MUX's, controllers, etc., and may be configured to facilitate communication between various elements of device 900. In some embodiments, portions of fabric 910 may be configured to implement various different communication protocols. In other embodiments, fabric 910 may implement a single communication protocol, and elements coupled to fabric 910 may convert from the single communication protocol to other communication protocols internally.

In the illustrated embodiment, compute complex 920 includes bus interface unit (BIU) 925, cache 930, and cores 935 and 940. In various embodiments, compute complex 920 may include various numbers of processors, processor cores, computation engines (e.g., computation engine 103), and cache memory circuits. For example, compute complex 920 may include 1, 2, or 4 processor cores, or any other suitable number. In one embodiment, cache 930 is a set associative L2 cache. In some embodiments, cores 935 and 940 may include internal instruction and data caches. In some embodiments, a coherency unit (not shown) in fabric 910, cache 930, or elsewhere in device 900 may be configured to maintain coherency between various caches of device 900. BIU 925 may be configured to manage communication between compute complex 920 and other elements of device 900. Processor cores, such as cores 935 and 940, may be configured to execute instructions of a particular instruction set architecture (ISA) which may include operating system instructions and user application instructions. These instructions may be stored in a computer readable medium such as a memory coupled to cache memory controller 945 as discussed below.

As used herein, the term “coupled to” may indicate one or more connections between elements, and a coupling may include intervening elements. For example, in FIG. 9, graphics unit 975 may be described as “coupled to” a memory through fabric 910 and cache/memory controller 945. In contrast, in the illustrated embodiment of FIG. 9, graphics unit 975 is “directly coupled” to fabric 910 because there are no intervening elements.

Cache/memory controller 945 may be configured to manage transfer of data between fabric 910 and one or more caches and memories. For example, cache/memory controller 945 may be coupled to an L3 cache, which may, in turn, be coupled to a system memory. In other embodiments, cache/memory controller 945 may be directly coupled to a memory. In some embodiments, cache/memory controller 945 may include one or more internal caches. Memory coupled to cache/memory controller 945 may be any type of volatile memory, such as dynamic random access memory (DRAM), synchronous DRAM (SDRAM), double data rate (DDR, DDR2, DDR3, etc.), SDRAM (including mobile versions of SDRAMs such as mDDR3, etc., and/or low power versions of SDRAMs such as LPDDR4, etc.), RAMBUS DRAM (RDRAM), static RAM (SRAM), etc. One or more memory devices may be coupled onto a circuit board to form memory modules such as single inline memory modules (SIMMs), dual inline memory modules (DIMMs), etc. Alternatively, the devices may be mounted with an integrated circuit in a chip-on-chip configuration, a package-on-package configuration, or a multi-chip module configuration. Memory coupled to cache/memory controller 945 may be any type of non-volatile memory such as NAND flash memory, NOR flash memory, nano RAM (NRAM), magneto-resistive RAM (MRAM), phase change RAM (PRAM), Racetrack memory, Memristor memory, etc. As noted above, this memory may store program instructions executable by compute complex 920 to cause the computing device to perform functionality described herein.

Graphics unit 975 may include one or more processors, e.g., one or more graphics processing units (GPUs). Graphics unit 975 may receive graphics-oriented instructions, such as OPENGL®, Metal®, or DIRECT3D® instructions, for example. Graphics unit 975 may execute specialized GPU instructions or perform other operations based on the received graphics-oriented instructions. Graphics unit 975 may generally be configured to process large blocks of data in parallel, and may build images in a frame buffer for output to a display, which may be included in the device or may be a separate device. Graphics unit 975 may include transform, lighting, triangle, and rendering engines in one or more graphics processing pipelines. Graphics unit 975 may output pixel information for display images. Graphics unit 975, in various embodiments, may include programmable shader circuitry, which may include highly parallel execution cores configured to execute graphics programs, which may include pixel tasks, vertex tasks, and compute tasks (which may or may not be graphics-related).

Display unit 965 may be configured to read data from a frame buffer and provide a stream of pixel values for display. Display unit 965 may be configured as a display pipeline in some embodiments. Additionally, display unit 965 may be configured to blend multiple frames to produce an output frame. Further, display unit 965 may include one or more interfaces (e.g., MIPI® or embedded display port (eDP)) for coupling to a user display (e.g., a touchscreen or an external display).

I/O bridge 950 may include various elements configured to implement universal serial bus (USB) communications, security, audio, and low-power always-on functionality, for example. I/O bridge 950 may also include interfaces such as pulse-width modulation (PWM), general-purpose input/output (GPIO), serial peripheral interface (SPI), inter-integrated circuit (I2C), and/or radio-frequency interfaces, for example. Various types of peripherals and devices may be coupled to device 900 via I/O bridge 950.

In some embodiments, device 900 includes network interface circuitry (not explicitly shown), which may be connected to fabric 910 or I/O bridge 950. The network interface circuitry may be configured to communicate via various networks, which may be wired, wireless, or both. For example, the network interface circuitry may be configured to communicate via a wired local area network, a wireless local area network (e.g., via Wi-Fi™), or a wide area network (e.g., the Internet or a virtual private network). In some embodiments, the network interface circuitry is configured to communicate via one or more cellular networks that use one or more radio access technologies. In some embodiments, the network interface circuitry is configured to communicate using device-to-device communications (e.g., Bluetooth® or Wi-Fi™ Direct, etc.). In various embodiments, the network interface circuitry may provide device 900 with connectivity to various types of other devices and networks.

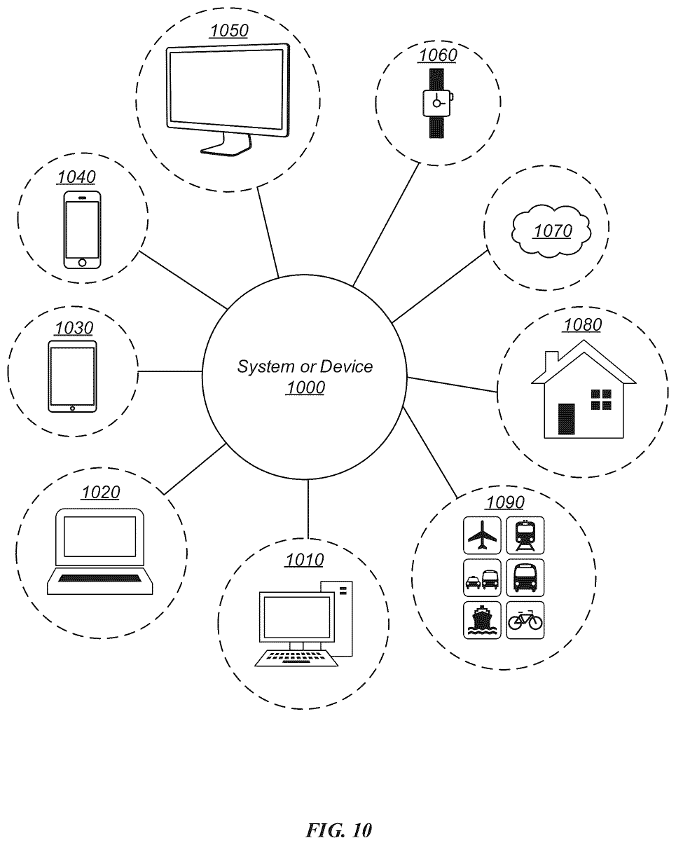

Turning now to FIG. 10, various types of systems that may include any of the circuits, devices, or systems discussed above are illustrated. System or device 1000, which may incorporate or otherwise utilize one or more of the techniques described herein, may be utilized in a wide range of areas. For example, system or device 1000 may be utilized as part of the hardware of systems such as a desktop computer 1010, laptop computer 1020, tablet computer 1030, cellular or mobile phone 1040, or television 1050 (or set-top box coupled to a television).

Similarly, disclosed elements may be utilized in a wearable device 1060, such as a smartwatch or a health-monitoring device. Smartwatches, in many embodiments, may implement a variety of different functions—for example, access to email, cellular service, calendar, health monitoring, etc. A wearable device may also be designed solely to perform health-monitoring functions, such as monitoring a user's vital signs, performing epidemiological functions such as contact tracing, providing communication to an emergency medical service, etc. Other types of devices are also contemplated, including devices worn on the neck, devices implantable in the human body, glasses or a helmet designed to provide computer-generated reality experiences such as those based on augmented and/or virtual reality, etc.

System or device 1000 may also be used in various other contexts. For example, system or device 1000 may be utilized in the context of a server computer system, such as a dedicated server or on shared hardware that implements a cloud-based service 1070. Still further, system or device 1000 may be implemented in a wide range of specialized everyday devices, including devices 1080 commonly found in the home such as refrigerators, thermostats, security cameras, etc. The interconnection of such devices is often referred to as the “Internet of Things” (IoT). Elements may also be implemented in various modes of transportation. For example, system or device 1000 could be employed in the control systems, guidance systems, entertainment systems, etc. of various types of vehicles 1090.

The applications illustrated in FIG. 10 are merely exemplary and are not intended to limit the potential future applications of disclosed systems or devices. Other example applications include, without limitation: portable gaming devices, music players, data storage devices, unmanned aerial vehicles, etc.

The present disclosure has described various example circuits in detail above. It is intended that the present disclosure cover not only embodiments that include such circuitry, but also a computer-readable storage medium that includes design information that specifies such circuitry. Accordingly, the present disclosure is intended to support claims that cover not only an apparatus that includes the disclosed circuitry, but also a storage medium that specifies the circuitry in a format that programs a computing system to generate a simulation model of the hardware circuit, programs a fabrication system configured to produce hardware (e.g., an integrated circuit) that includes the disclosed circuitry, etc. Claims to such a storage medium are intended to cover, for example, an entity that produces a circuit design, but does not itself perform complete operations such as: design simulation, design synthesis, circuit fabrication, etc.

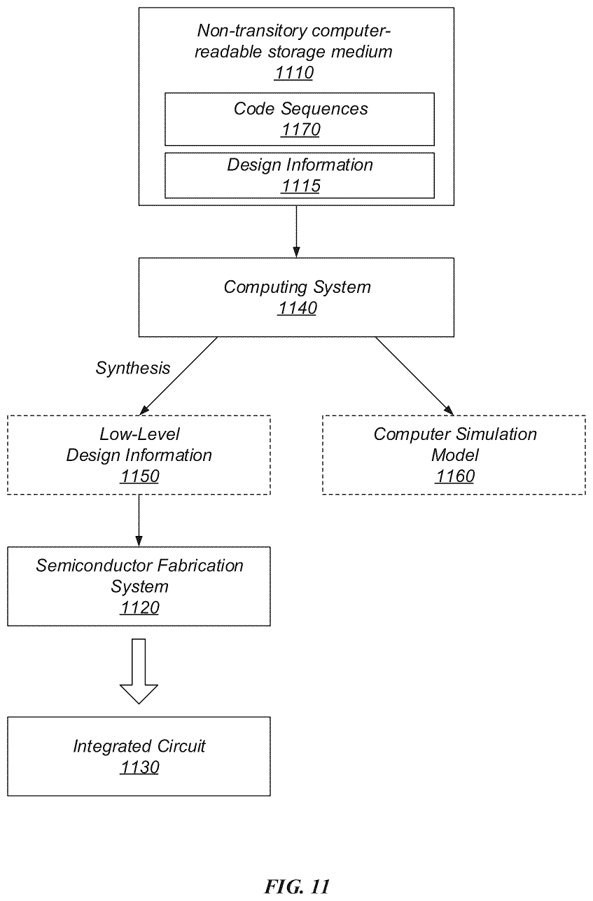

FIG. 11 is a block diagram illustrating an example of a non-transitory computer-readable storage medium that stores circuit design information 1115 and code sequences 1170, according to some embodiments. In the illustrated embodiment, computing system 1140 is configured to process design information 1115. This may include executing instructions included in design information 1115, interpreting instructions included in design information 1115, compiling, transforming, or otherwise updating design information 1115, etc. Therefore, design information 1115 controls computing system 1140 (e.g., by programming computing system 1140) to perform various operations discussed below, in some embodiments.

In the illustrated example, computing system 1140 processes design information 1115 to generate both computer simulation model 1160 of integrated circuit 1130 and low-level design information 1150. In other embodiments, computing system 1140 may generate only one of these outputs, may generate other outputs based on design information 1115, or both. Regarding computer simulation model 1160, computing system 1140 may execute instructions of a hardware description language that includes register transfer level (RTL) code, behavioral code, structural code, or some combination thereof. The simulation model may perform the functionality specified by design information 1115, facilitate verification of the functional correctness of the hardware design, generate power consumption estimates, generate timing estimates, etc.

In the illustrated example, computing system 1140 also processes design information 1115 to generate low-level design information 1150 (e.g., gate-level design information, a netlist, etc.). This may include synthesis operations, as shown, such as constructing a multi-level network, optimizing the network using technology-independent techniques, technology dependent techniques, or both, and outputting a network of gates (with potential constraints based on available gates in a technology library, sizing, delay, power, etc.). Based on low-level design information 1150 (potentially among other inputs), semiconductor fabrication system 1120 is configured to fabricate integrated circuit 1130 (which may correspond to functionality of computer simulation model 1160). Note that computing system 1140 may generate different simulation models based on design information at various levels of description, including low-level design information 1150, design information 1115, and so on. The data representing low-level design information 1150 and computer simulation model 1160 may be stored on non-transitory computer readable storage medium 1110, or on one or more other media.

In some embodiments, low-level design information 1150 controls (e.g., programs) semiconductor fabrication system 1120 to fabricate integrated circuit 1130. Thus, when processed by the fabrication system, the design information may program the fabrication system to fabricate a circuit that includes various circuitry disclosed herein.

Non-transitory computer-readable storage medium 1110 may comprise any of various appropriate types of memory devices or storage devices. Non-transitory computer-readable storage medium 1110 may be an installation medium, e.g., a CD-ROM, floppy disks, or tape device; a computer system memory or random access memory such as DRAM, DDR RAM, SRAM, EDO RAM, Rambus RAM, etc.; a non-volatile memory such as a Flash, magnetic media, e.g., a hard drive, or optical storage; registers, or other similar types of memory elements, etc. Non-transitory computer-readable storage medium 1110 may include other types of non-transitory memory as well or combinations thereof. Accordingly, non-transitory computer-readable storage medium 1110 may include two or more memory media; such media may reside in different locations—for example, in different computer systems that are connected over a network.

Design information 1115 may be specified using any of various appropriate computer languages, including hardware description languages such as, without limitation: VHDL, Verilog, SystemC, SystemVerilog, RHDL, M, MyHDL, etc. The format of various design information may be recognized by one or more applications executed by computing system 1140, semiconductor fabrication system 1120, or both. In some embodiments, design information 1115 may also include one or more cell libraries that specify the synthesis, layout, or both of integrated circuit 1130. In some embodiments, design information 1115 is specified in whole, or in part, in the form of a netlist that specifies cell library elements and their connectivity. Design information discussed herein, taken alone, may or may not include sufficient information for fabrication of a corresponding integrated circuit. For example, design information may specify the circuit elements to be fabricated but not their physical layout. In this case, design information may be combined with layout information to actually fabricate the specified circuitry.

Code sequences 1170 may include one or more instructions that make use of computation engine 103. In some cases, code sequences 1170 may include one or more instances of a vector outer product and accumulate instruction as described above.

Integrated circuit 1130 may, in various embodiments, include one or more custom macrocells, such as memories, analog or mixed-signal circuits, and the like. In such cases, design information 1115 may include information related to included macrocells. Such information may include, without limitation, schematics capture database, mask design data, behavioral models, and device or transistor level netlists. Mask design data may be formatted according to graphic data system (GDSII), or any other suitable format.

Semiconductor fabrication system 1120 may include any of various appropriate elements configured to fabricate integrated circuits. This may include, for example, elements for depositing semiconductor materials (e.g., on a wafer, which may include masking), removing materials, altering the shape of deposited materials, modifying materials (e.g., by doping materials or modifying dielectric constants using ultraviolet processing), etc. Semiconductor fabrication system 1120 may also be configured to perform various testing of fabricated circuits for correct operation.

In various embodiments, integrated circuit 1130 and computer simulation model 1160 are configured to operate according to a circuit design specified by design information 1115, which may include performing any of the functionality described herein. For example, integrated circuit 1130 may include any of various elements shown in FIGS. 1-4. Further, integrated circuit 1130 may be configured to perform various functions described herein in conjunction with other components. Further, the functionality described herein may be performed by multiple connected integrated circuits.

As used herein, a phrase of the form “design information that specifies a design of a circuit configured to . . . ” does not imply that the circuit in question must be fabricated in order for the element to be met. Rather, this phrase indicates that the design information describes a circuit that, upon being fabricated, will be configured to perform the indicated actions or will include the specified components. Similarly, stating “instructions of a hardware description programming language” that are “executable” to program a computing system to generate a computer simulation model does not imply that the instructions must be executed in order for the element to be met, but rather, specifies characteristics of the instructions. Additional features relating to the model (or the circuit represented by the model) may similarly relate to characteristics of the instructions, in this context. Therefore, an entity that sells a computer-readable medium with instructions that satisfy recited characteristics may provide an infringing product, even if another entity actually executes the instructions on the medium.

Note that a given design, at least in the digital logic context, may be implemented using a multitude of different gate arrangements, circuit technologies, etc. As one example, different designs may select or connect gates based on design tradeoffs (e.g., to focus on power consumption, performance, circuit area, etc.). Further, different manufacturers may have proprietary libraries, gate designs, physical gate implementations, etc. Different entities may also use different tools to process design information at various layers (e.g., from behavioral specifications to physical layout of gates).

Once a digital logic design is specified, however, those skilled in the art need not perform substantial experimentation or research to determine those implementations. Rather, those of skill in the art understand procedures to reliably and predictably produce one or more circuit implementations that provide the function described by design information 1115. The different circuit implementations may affect the performance, area, power consumption, etc. of a given design (potentially with tradeoffs between different design goals), but the logical function does not vary among the different circuit implementations of the same circuit design.

In some embodiments, the instructions included in design information 1115 provide RTL information (or other higher-level design information) and are executable by the computing system to synthesize a gate-level netlist that represents the hardware circuit based on the RTL information as an input. Similarly, the instructions may provide behavioral information and be executable by the computing system to synthesize a netlist or other lower-level design information included in low-level design information 1150. Low-level design information 1150 may program semiconductor fabrication system 1120 to fabricate integrated circuit 1130.

The present disclosure includes references to an “embodiment” or groups of “embodiments” (e.g., “some embodiments” or “various embodiments”). Embodiments are different implementations or instances of the disclosed concepts. References to “an embodiment,” “one embodiment,” “a particular embodiment,” and the like do not necessarily refer to the same embodiment. A large number of possible embodiments are contemplated, including those specifically disclosed, as well as modifications or alternatives that fall within the spirit or scope of the disclosure.

This disclosure may discuss potential advantages that may arise from the disclosed embodiments. Not all implementations of these embodiments will necessarily manifest any or all of the potential advantages. Whether an advantage is realized for a particular implementation depends on many factors, some of which are outside the scope of this disclosure. In fact, there are a number of reasons why an implementation that falls within the scope of the claims might not exhibit some or all of any disclosed advantages. For example, a particular implementation might include other circuitry outside the scope of the disclosure that, in conjunction with one of the disclosed embodiments, negates or diminishes one or more of the disclosed advantages. Furthermore, suboptimal design execution of a particular implementation (e.g., implementation techniques or tools) could also negate or diminish disclosed advantages. Even assuming a skilled implementation, realization of advantages may still depend upon other factors such as the environmental circumstances in which the implementation is deployed. For example, inputs supplied to a particular implementation may prevent one or more problems addressed in this disclosure from arising on a particular occasion, with the result that the benefit of its solution may not be realized. Given the existence of possible factors external to this disclosure, it is expressly intended that any potential advantages described herein are not to be construed as claim limitations that must be met to demonstrate infringement. Rather, identification of such potential advantages is intended to illustrate the type(s) of improvement available to designers having the benefit of this disclosure. That such advantages are described permissively (e.g., stating that a particular advantage “may arise”) is not intended to convey doubt about whether such advantages can in fact be realized, but rather to recognize the technical reality that realization of such advantages often depends on additional factors.

Unless stated otherwise, embodiments are non-limiting. That is, the disclosed embodiments are not intended to limit the scope of claims that are drafted based on this disclosure, even where only a single example is described with respect to a particular feature. The disclosed embodiments are intended to be illustrative rather than restrictive, absent any statements in the disclosure to the contrary. The application is thus intended to permit claims covering disclosed embodiments, as well as such alternatives, modifications, and equivalents that would be apparent to a person skilled in the art having the benefit of this disclosure.

For example, features in this application may be combined in any suitable manner. Accordingly, new claims may be formulated during prosecution of this application (or an application claiming priority thereto) to any such combination of features. In particular, with reference to the appended claims, features from dependent claims may be combined with those of other dependent claims where appropriate, including claims that depend from other independent claims. Similarly, features from respective independent claims may be combined where appropriate.

Accordingly, while the appended dependent claims may be drafted such that each depends on a single other claim, additional dependencies are also contemplated. Any combinations of features in the dependent claims that are consistent with this disclosure are contemplated and may be claimed in this or another application. In short, combinations are not limited to those specifically enumerated in the appended claims.

Where appropriate, it is also contemplated that claims drafted in one format or statutory type (e.g., apparatus) are intended to support corresponding claims of another format or statutory type (e.g., method).

Because this disclosure is a legal document, various terms and phrases may be subject to administrative and judicial interpretation. Public notice is hereby given that the following paragraphs, as well as definitions provided throughout the disclosure, are to be used in determining how to interpret claims that are drafted based on this disclosure.

References to a singular form of an item (i.e., a noun or noun phrase preceded by “a,” “an,” or “the”) are, unless context clearly dictates otherwise, intended to mean “one or more.” Reference to “an item” in a claim thus does not, without accompanying context, preclude additional instances of the item. A “plurality” of items refers to a set of two or more of the items.

The word “may” is used herein in a permissive sense (i.e., having the potential to, being able to) and not in a mandatory sense (i.e., must).

The terms “comprising” and “including,” and forms thereof, are open-ended and mean “including, but not limited to.”

When the term “or” is used in this disclosure with respect to a list of options, it will generally be understood to be used in the inclusive sense unless the context provides otherwise. Thus, a recitation of “x or y” is equivalent to “x or y, or both,” and thus covers 1) x but not y, 2) y but not x, and 3) both x and y. On the other hand, a phrase such as “either x or y, but not both” makes clear that “or” is being used in the exclusive sense.

A recitation of “w, x, y, or z, or any combination thereof” or “at least one of . . . w, x, y, and z” is intended to cover all possibilities involving a single element up to the total number of elements in the set. For example, given the set [w, x, y, z], these phrasings cover any single element of the set (e.g., w but not x, y, or z), any two elements (e.g., w and x, but not y or z), any three elements (e.g., w, x, and y, but not z), and all four elements. The phrase “at least one of . . . w, x, y, and z” thus refers to at least one element of the set [w, x, y, z], thereby covering all possible combinations in this list of elements. This phrase is not to be interpreted to require that there is at least one instance of w, at least one instance of x, at least one instance of y, and at least one instance of z.

Various “labels” may precede nouns or noun phrases in this disclosure. Unless context provides otherwise, different labels used for a feature (e.g., “first circuit,” “second circuit,” “particular circuit,” “given circuit,” etc.) refer to different instances of the feature. Additionally, the labels “first,” “second,” and “third,” when applied to a feature, do not imply any type of ordering (e.g., spatial, temporal, logical, etc.), unless stated otherwise.

The phrase “based on” is used to describe one or more factors that affect a determination. This term does not foreclose the possibility that additional factors may affect the determination. That is, a determination may be solely based on specified factors, or based on the specified factors as well as other, unspecified factors. Consider the phrase “determine A based on B.” This phrase specifies that B is a factor that is used to determine A or that affects the determination of A. This phrase does not foreclose that the determination of A may also be based on some other factor, such as C. This phrase is also intended to cover an embodiment in which A is determined based solely on B. As used herein, the phrase “based on” is synonymous with the phrase “based at least in part on.”

The phrases “in response to” and “responsive to” describe one or more factors that trigger an effect. This phrase does not foreclose the possibility that additional factors may affect or otherwise trigger the effect, either jointly with the specified factors or independent from the specified factors. That is, an effect may be solely in response to those factors, or may be in response to the specified factors as well as other, unspecified factors. Consider the phrase “perform A in response to B.” This phrase specifies that B is a factor that triggers the performance of A, or that triggers a particular result for A. This phrase does not foreclose that performing A may also be in response to some other factor, such as C. This phrase also does not foreclose that performing A may be jointly in response to B and C. This phrase is also intended to cover an embodiment in which A is performed solely in response to B. As used herein, the phrase “responsive to” is synonymous with the phrase “responsive at least in part to.” Similarly, the phrase “in response to” is synonymous with the phrase “at least in part in response to.”

Within this disclosure, different entities (which may variously be referred to as “units,” “circuits,” other components, etc.) may be described or claimed as “configured” to perform one or more tasks or operations. This formulation—[entity] configured to [perform one or more tasks]—is used herein to refer to structure (i.e., something physical). More specifically, this formulation is used to indicate that this structure is arranged to perform the one or more tasks during operation. A structure can be said to be “configured to” perform some task even if the structure is not currently being operated. Thus, an entity described or recited as being “configured to” perform some task refers to something physical, such as a device, a circuit, or a system having a processor unit and a memory storing program instructions executable to implement the task, etc. This phrase is not used herein to refer to something intangible.

In some cases, various units/circuits/components may be described herein as performing a set of tasks or operations. It is understood that those entities are “configured to” perform those tasks/operations, even if not specifically noted.

The term “configured to” is not intended to mean “configurable to.” An unprogrammed FPGA, for example, would not be considered to be “configured to” perform a particular function. This unprogrammed FPGA may be “configurable to” perform that function, however. After appropriate programming, the FPGA may then be said to be “configured to” perform the particular function.

For purposes of United States patent applications based on this disclosure, reciting in a claim that a structure is “configured to” perform one or more tasks is expressly intended not to invoke 35 U.S.C. § 112(f) for that claim element. Should Applicant wish to invoke Section 112(f) during prosecution of a United States patent application based on this disclosure, it will recite claim elements using the “means for” [performing a function] construct.

Different “circuits” may be described in this disclosure. These circuits or “circuitry” constitute hardware that includes various types of circuit elements, such as combinatorial logic, clocked storage devices (e.g., flip-flops, registers, latches, etc.), finite state machines, memory (e.g., random-access memory, embedded dynamic random-access memory), programmable logic arrays, and so on. Circuitry may be custom designed, or taken from standard libraries. In various implementations, circuitry can, as appropriate, include digital components, analog components, or a combination of both. Certain types of circuits may be commonly referred to as “units” (e.g., a decode unit, an arithmetic logic unit (ALU), a functional unit, a memory management unit (MMU), etc.). Such units also refer to circuits or circuitry.

The disclosed circuits/units/components and other elements illustrated in the drawings and described herein thus include hardware elements such as those described in the preceding paragraph. In many instances, the internal arrangement of hardware elements within a particular circuit may be specified by describing the function of that circuit. For example, a particular “decode unit” may be described as performing the function of “processing an opcode of an instruction and routing that instruction to one or more of a plurality of functional units,” which means that the decode unit is “configured to” perform this function. This specification of function is sufficient, to those skilled in the computer arts, to connote a set of possible structures for the circuit.

In various embodiments, as discussed in the preceding paragraph, circuits, units, and other elements may be defined by the functions or operations that they are configured to implement. The arrangement of such circuits/units/components with respect to each other and the manner in which they interact form a microarchitectural definition of the hardware that is ultimately manufactured in an integrated circuit or programmed into an FPGA to form a physical implementation of the microarchitectural definition. Thus, the microarchitectural definition is recognized by those of skill in the art as a structure from which many physical implementations may be derived, all of which fall into the broader structure described by the microarchitectural definition. That is, a skilled artisan presented with the microarchitectural definition supplied in accordance with this disclosure may, without undue experimentation and with the application of ordinary skill, implement the structure by coding the description of the circuits/units/components in a hardware description language (HDL) such as Verilog or VHDL. The HDL description is often expressed in a fashion that may appear to be functional. But to those of skill in the art in this field, this HDL description is the manner that is used to transform the structure of a circuit, unit, or component to the next level of implementational detail. Such an HDL description may take the form of behavioral code (which is typically not synthesizable), register transfer language (RTL) code (which, in contrast to behavioral code, is typically synthesizable), or structural code (e.g., a netlist specifying logic gates and their connectivity). The HDL description may subsequently be synthesized against a library of cells designed for a given integrated circuit fabrication technology, and may be modified for timing, power, and other reasons to result in a final design database that is transmitted to a foundry to generate masks and ultimately produce the integrated circuit. Some hardware circuits, or portions thereof, may also be custom-designed in a schematic editor and captured into the integrated circuit design along with synthesized circuitry. The integrated circuits may include transistors and other circuit elements (e.g., passive elements such as capacitors, resistors, inductors, etc.) and interconnect between the transistors and circuit elements. Some embodiments may implement multiple integrated circuits coupled together to implement the hardware circuits, and/or discrete elements may be used in some embodiments. Alternatively, the HDL design may be synthesized to a programmable logic array such as a field programmable gate array (FPGA) and may be implemented in the FPGA. This decoupling between the design of a group of circuits and the subsequent low-level implementation of these circuits commonly results in the scenario in which the circuit or logic designer never specifies a particular set of structures for the low-level implementation beyond a description of what the circuit is configured to do, as this process is performed at a different stage of the circuit implementation process.

The fact that many different low-level combinations of circuit elements may be used to implement the same specification of a circuit results in a large number of equivalent structures for that circuit. As noted, these low-level circuit implementations may vary according to changes in the fabrication technology, the foundry selected to manufacture the integrated circuit, the library of cells provided for a particular project, etc. In many cases, the choices made by different design tools or methodologies to produce these different implementations may be arbitrary.

Moreover, it is common for a single implementation of a particular functional specification of a circuit to include, for a given embodiment, a large number of devices (e.g., millions of transistors). Accordingly, the sheer volume of this information makes it impractical to provide a full recitation of the low-level structure used to implement a single embodiment, let alone the vast array of equivalent possible implementations. For this reason, the present disclosure describes structure of circuits using the functional shorthand commonly employed in the industry.

### APPENDIX A

### Pseudocode for Crossbar Outer Product and Accumulate Instruction

```
integer a = UInt(Pn);
integer n = UInt(Zn);
integer m = UInt(Zm);
integer k = UInt(Zk);
integer da = UInt(ZAda);
boolean sub_op = FALSE;
constant integer VL = CurrentVL;
constant integer PL = VL DIV 8;
constant integer dim = VL DIV esize;
bits(PL) mask1 = P[a, PL];
bits(VL) select_vec = Z[k, VL];
bits(VL) operand1a = Z[n, VL];
bits(VL) operand1b = Z[n+1, VL];
bits(VL) operand1c = Z[n+2, VL];
bits(VL) operand2 = Z[m, VL];
bits(dim*dim*esize) operand3 = ZAtile[da, esize, dim*dim*esize];
bits(dim*dim*esize) result;
for row = 0 to dim−1
  for col = 0 to dim−1
    Bits(esize) select_elt = Elem[select_vec, col * esize /
2, 2];
    Bits(VL) operand1;
    if (select_elt == 0b01) then operand1 = operand1a
    else if (select_elt == 0b10) then operand1 = operand1b
    else if (select_elt == 0b11) then operand1 = operand1c
    bits(esize) element1 = Elem[operand1, row, esize];
    bits(esize) element2 = Elem[operand2, col, esize];
    bits(esize) element3 = Elem[operand3, row*dim+col,
esize];
    if (ActivePredicateElement(mask1, row, esize)
&& select_elt != 0b00 ) then
      if sub_op then element1 = FPNeg(element1, FPCR);
      Elem[result, row*dim+col, esize] =
FPMulAdd_ZA(element3, element1, element2, FPCR);
    else
      Elem[result, row*dim+col, esize] = element3;
ZAtile[da, esize, dim*dim*esize] = result;
```

What is claimed is:

1. An apparatus, comprising:
a plurality of register circuits configured to store corresponding vectors of a plurality of vectors; and
a computation engine including a plurality of compute elements disposed in an array of rows and columns, wherein the computation engine is configured to:
select a first portion of a first input vector from a first register circuit of the plurality of register circuits using a selection vector stored in a particular register circuit of the plurality of register circuits;
select, using the selection vector, a second portion of a second input vector from a second register circuit of the plurality of register circuits; and
perform, in parallel, using the plurality of compute elements, a plurality of computations using the first portion of the first input vector, the second portion of the second input vector, and a weight vector, wherein the plurality of computations are included in a vector outer-product computation, and wherein the weight vector is stored in a different register circuit of the plurality of register circuits.

2. The apparatus of claim 1, wherein a first number of zero elements included in the first portion of the first input vector is less than a threshold value, and wherein a second number of zero elements included in the second portion of the second input vector is less than the threshold value.

3. The apparatus of claim 1, wherein a particular row of compute circuits of the plurality of compute elements are coupled to a first communication bus, and wherein a different row of compute circuits of the plurality of compute elements is coupled to the first communication bus.

4. The apparatus of claim 3, wherein the computation engine is further configured to:
transfer, using the first communication bus during a first pass, a particular element of the first portion of the first input vector to corresponding compute circuits included in the particular row of compute circuits; and
transfer, using the first communication bus during a second pass, a different element of the first portion of the first input vector to corresponding compute circuits included in the different row of compute circuits.

5. The apparatus of claim 1, wherein to perform the plurality of computations, the computation engine is further configured to perform respective operations of a plurality of operations using a particular element of the first portion of the first input vector and corresponding elements of the weight vector.

6. The apparatus of claim 1, wherein a given computation of the plurality of computations includes a multiply-and-accumulate operation.

7. A method, comprising:
selecting, by a computation engine included in a computer system using a selection vector from a particular register circuit of a plurality of register circuit, a first portion of a first input vector from a different register circuit of the plurality of register circuits using the selection vector, wherein the computation engine includes a plurality of compute circuits arranged in an array of rows and columns;
selecting, by the computation engine using the selection vector, a second portion of a second input vector from another register circuit of the plurality of register circuits; and
performing, in parallel by the plurality of compute elements, a plurality of computations using the first portion of the first input vector, the second portion of the second input vector, and a weight vector, wherein the plurality of computations are included in a vector outer-product computation, and wherein the weight vector is stored in a given register circuit of the plurality of register circuits.

8. The method of claim 7, wherein a first number of zero elements included in the first portion of the first input vector is less than a threshold value, and wherein a second number of zero elements included in the second portion of the second input vector is less than the threshold value.

9. The method of claim 7, wherein a particular row of compute circuits of the plurality of compute circuits is coupled to a first communication bus, and wherein a different row of compute circuits of the plurality of compute circuits is coupled to the first communication bus.

10. The method of claim 9, further comprising:
transferring, by the computation engine using the first communication bus during a first pass, a particular element of the first portion of the first input vector to corresponding compute circuits included in the particular row of compute circuits; and
transferring, by the computation engine using the first communication bus during a second pass, a different element of the first portion of the first input vector to corresponding compute circuits included in the different row of compute circuits.

11. The method of claim 7, wherein performing the plurality of computations includes performing respective operations of a plurality of operations using a particular element of the first portion of the first input vector and corresponding elements of the weight vector.

12. The method of claim 7, wherein a given computation of the plurality of computations includes a multiply-and-accumulate operation.

13. The method of claim 7, wherein the weight vector is included in a weight matrix, and wherein a number of zero elements included in the weight matrix exceeds a threshold value.

14. A system, comprising:
a processor circuit configured to:
retrieve, in response to executing a first instruction, an input matrix and a weight matrix, wherein the input matrix includes a plurality of input vectors, wherein the weight matrix includes a plurality of weight vectors, and wherein a number of zero elements included in the weight matrix exceeds a threshold value; and
generate, in response to executing the first instruction, a packed weight vector that includes an orthogonal subset of the plurality of weight vectors; and
a computation engine configured to perform, in parallel, a plurality of computations using a subset of the plurality of input vectors corresponding to the subset of the plurality of weight vectors included in the packed weight vector, wherein the computation engine includes a plurality of compute elements.

15. The system of claim 14, wherein the plurality of computations includes a respective plurality of vector multiplication operations.

16. The system of claim 14, wherein to generate the packed weight vector, the processor circuit is further configured to store information in a lookup table, wherein the information maps particular weights included in the subset of the plurality of weight vectors to corresponding input vectors included in the subset of the plurality of input vectors.

17. The system of claim 16, wherein to perform the plurality of computations, the computation engine is further configured to retrieve the information from the lookup table.

18. The system of claim 16, wherein a given compute element of the plurality of compute elements is configured to store a particular weight value included in the packed weight vector based on the information stored in the lookup table.

19. The system of claim 14, wherein the processor circuit is further configured to:
generate a second instruction using the first instruction; and
send the second instruction to the computation engine.

20. The system of claim 19, wherein the computation engine is further configured to perform the plurality of computations in response to receiving the second instruction.
